(19) United States
(12) Patent Application Publication
(10) Pub. No.: US 2010/0232458 A1
(43) Pub. Date: Sep. 16, 2010

(54) Wavelength Tunable External Cavity Laser

(76) Inventors: Byoung-Whi Kim, Daejeon-city (KR); Mahn-Yong Park, Gwangiu-city (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/225,407

(22) PCT Filed: Apr. 20, 2007
(86) PCT No.: PCT/KR2007/001931

§ 371 Date: Sep. 18, 2008

(30) Foreign Application Priority Data
Apr. 20, 2006 (KR) 10-2006-0035774
Sep. 29, 2006 (KR) 10-2006-0096600

(51) Int. Cl. H01S 3/10

(52) U.S. Cl. 372/20

(57) ABSTRACT

Provided is a wavelength tunable external cavity laser comprising: a semiconductor laser diode that outputs multi-wavelength optical signals and is mounted on a first substrate; and a wavelength tunable reflection filter that is mounted on a second substrate, outputs single wavelength optical signals among the multi-wavelength optical signals using resonance of external cavity formed between a semiconductor laser diode and a Bragg-grating having a predetermined period, and tunes the wavelength of the output single wavelength optical signal by varying the refractive index of the Bragg-grating. The wavelength tunable Bragg-grating reflection filter and the semiconductor laser diode are mounted on separate substrates, and the optical coupling efficiency between the semiconductor laser diode and the waveguide type Bragg-grating reflection filter is increased using an active alignment method to increase the optical output power and enable a stable oscillation mode.

### CROSS-REFERENCE TO RELATED PATENT APPLICATION

This application claims the benefit of Korean Patent Application Nos. 10-2006-0035774, filed on Apr. 20, 2006, and 10-2006-96600, filed on Sep. 20, 2006, in the Korean Intellectual Property Office, the disclosures of which are incorporated herein in their entirety by reference.

### BACKGROUND OF THE INVENTION

1. Field of the Invention

The present invention relates to a wavelength tunable external cavity laser, and more particularly, to a laser of which the wavelength of the output optical signal can be controlled using a reflection filter having a grating as an external cavity.

2. Description of the Related Art

As the society becomes more information-oriented, and internet use increases, the amount of communication is increasing by a geometric progression, and there is an increasing demand for high capacity optical communication for accommodating this communication.

Thus the speeds of optical signals have been increased to increase the capacity of optical communication. However, the speeds have reached a limit of 10 to 40 Gbps. One common method of overcoming this limit is a wavelength division multiplexing (WDM) method, in which several wavelengths are transmitted through one optical fiber.

A passive optical network (PON) based on WDM (hereinafter WDM-PON) carries out communication between a central station and subscribers through wavelengths which are allocated for each subscriber.

Since each subscriber uses their own wavelength, security is excellent, high capacity communication service is possible, and different transmission techniques can be applied for each subscriber or each service, for example, link rate, frame format, etc.

However, as the WDM-PON uses several wavelengths for one optical fiber, as many light sources as subscribers belonging to a remote node (RN) are required.

Demand of the light source for each wavelength increases the cost of operating WDM-PON for the users and the operators, thereby making the WDM-PON impractical for common use.

In order to overcome this problem, a tunable light source that can selectively tune the wavelength of its output light has been studied.

A wavelength tunable external cavity laser has a simple structure for a semiconductor laser diode, and uses an external wavelength tunable Bragg-grating reflection filter.

To reduce the cost of the light source, a hybrid integration method is typically used, in which a wavelength tunable Bragg-grating reflection filter and a semiconductor laser diode are mounted together on a waveguide platform.

The hybrid integration method gives a lower optical coupling efficiency, due to the alignment error of a flip-chip bonding apparatus, compared to an active alignment method, and needs an expensive laser diode having an integrated spot-size converter.

### SUMMARY OF THE INVENTION

The present invention provides a wavelength tunable external cavity laser having a stable optical coupling efficiency and oscillation characteristics in which a wavelength tunable waveguide type Bragg-grating reflection filter and a semiconductor laser diode are optically coupled not by a passive alignment method but by an active alignment method using separate substrates.

According to an aspect of the present invention, there is provided a wavelength tunable external cavity laser comprising: a semiconductor laser diode that outputs multi-wavelength optical signals and is mounted on a first substrate; and a wavelength tunable reflection filter that is mounted on a second substrate, outputs single wavelength optical signal among the multi-wavelength optical signals using resonance of a Bragg-grating having a predetermined period, and tunes the wavelength of the output single wavelength optical signal by varying the refractive index of the Bragg-grating.

### BRIEF DESCRIPTION OF THE DRAWINGS

The above and other features and advantages of the present invention will become more apparent by describing in detail exemplary embodiments thereof with reference to the attached drawings in which:

FIG. 1 includes a top view (a) and a side view (b) of a wavelength tunable external cavity laser in which a waveguide type Bragg-grating reflection filter and a semiconductor laser diode are mounted on a single platform;

FIG. 2 includes a perspective view (a) of a waveguide type Bragg-grating reflection filter structure and a graph (b) of refractive index according to temperature;

FIG. 3 includes a top view (a) and a side view (b) of a wavelength tunable external cavity laser where a semiconductor laser diode and a wavelength-tuneable Bragg-grating reflection filter are optically coupled using a coupling lens according to an embodiment of the present invention;

FIG. 4 includes a top view (a) and a side view (b) of a wavelength tunable external cavity laser where a semiconductor laser diode and a wavelength-tuneable Bragg-grating reflection filter are optically coupled without a coupling lens according to another embodiment of the present invention; and

FIG. 5 illustrates the operation principle of the wavelength tunable external cavity laser according to an embodiment of the present invention.

### DETAILED DESCRIPTION OF THE INVENTION

The present invention will now be described more fully with reference to the accompanying drawings, in which exemplary embodiments of the invention are shown.

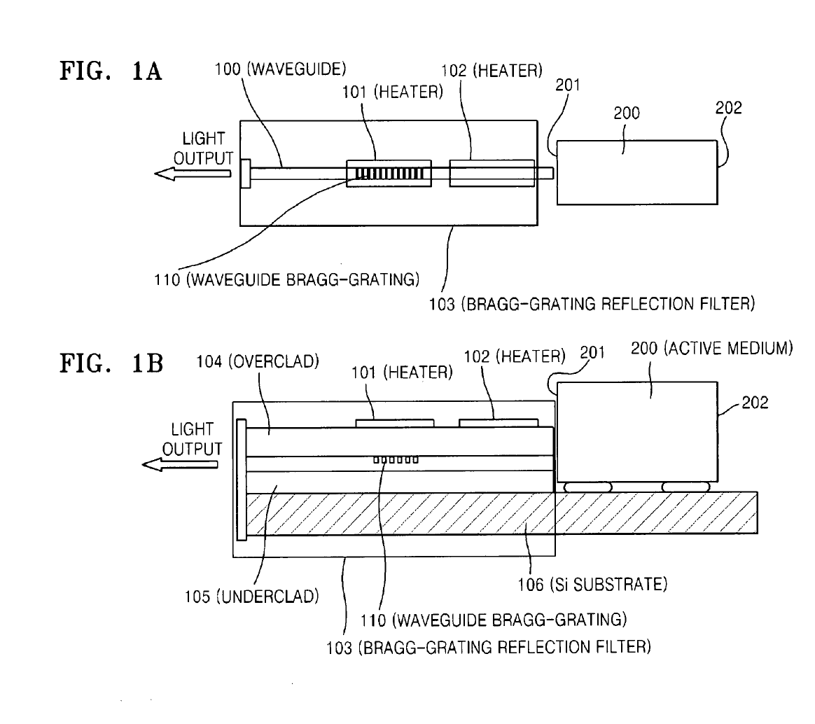

FIG. 1 includes a top view (a) and a side view (b) of a wavelength tunable external cavity laser in which a waveguide type Bragg-grating reflection filter and a semiconductor laser diode are mounted on a waveguide platform.

An front facet 201 of the semiconductor laser diode 200 is anti-reflection (AR) coated, and a rear surface 202 is high-reflection (HR) coated.

When the light emitted from the AR-coated front facet 201 is optically coupled to a wavelength tunable Bragg-grating reflection filter 103 that can tune the wavelength of the light, an external cavity is formed between the semiconductor laser diode and a reflection filter in which a grating is carved.

The oscillation wavelength of the resonance is determined by the reflection band of the Bragg-grating 110.

Also, for fine adjustment of the oscillation wavelength, an additional heater for adjusting phase can be added.

Typically, in an external cavity laser, the semiconductor laser diode 200 is passively aligned and mounted using a flip-chip bonding method on a waveguide platform 100 in which the Bragg-grating reflection filter 103 is integrated.

In this case, the optical coupling efficiency is determined by the far-field angle of the output light of the semiconductor laser diode 200.

Typically, an optical coupling efficiency of up to about 40% can be obtained using a far-field angle of 20 degrees or less.

However, a spot-size converter should be integrated at a front facet of the semiconductor laser diode for a far-field angle of 20 degree or less, thus increasing the price of the optical device, and it is difficult to obtain a stable optical coupling efficiency because the passive alignment methods still show a large variation in alignment offset.

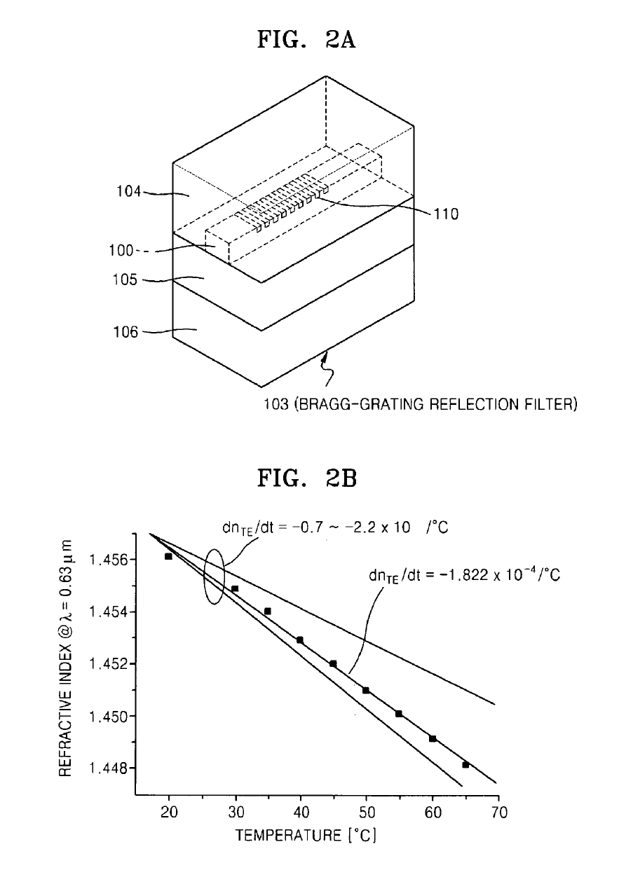

FIG. 2 includes a perspective view (a) of a waveguide type Bragg-grating reflection filter structure and a graph (b) of variation of refractive index according to temperature.

The wavelength tunable Bragg-grating reflection filter 103 forms a waveguide Bragg-grating 110 having a predetermined period in a core region 100, and uses a thermo-optic effect by having a thin-film heater 101 deposited in the upper portion of an overclad 104.

The grating can be formed by wet or dry etching a portion of the core region, using an ultraviolet reactive core material having a periodically varying refractive index.

Here, the Bragg-grating 110 is formed by etching the waveguide core region 100 at periodic intervals.

Thin-film heaters 101 and 102 are formed by depositing metal such as Cr, Au, Ni, Ni—Cr.

When a current is applied to the thin-film heaters 101 and 102, the temperature increases locally, and the refractive index is increased or decreased by a thermo-optic effect, thereby tuning the reflection band of the Bragg-grating.

Typically, when the temperature is increased, the refractive index of a metal oxide material increases but the refractive index of a polymer material decreases.

The graph (b) of FIG. 2 shows the variation of the refractive index according to the temperature change of a polymer material.

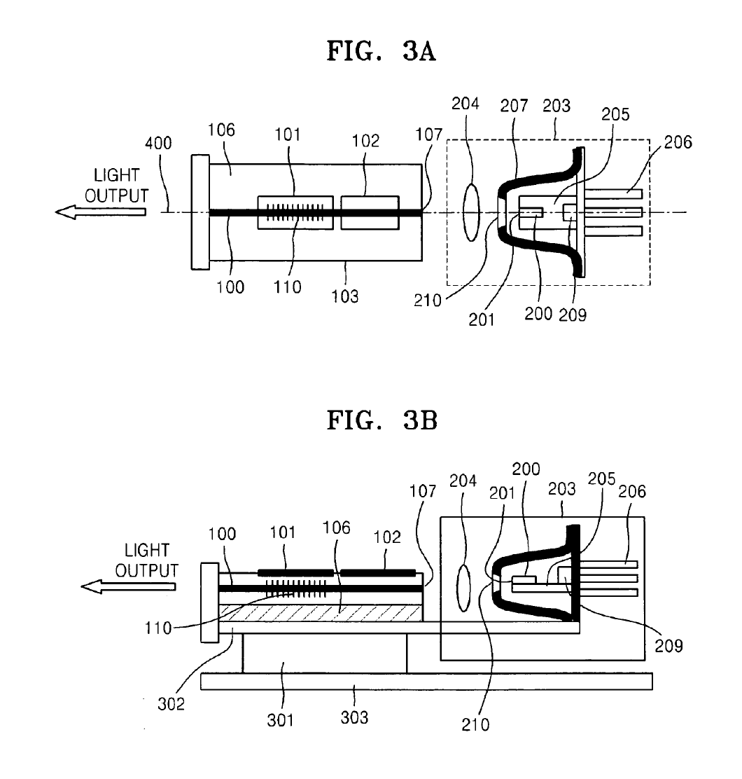

For an optical signal with a wavelength λ=0.63 um, the refractive index of the polymer material decreases as the temperature increases. FIG. 3 includes a top view (a) and a side view (b) of a wavelength tunable external cavity laser where a semiconductor laser diode and a wavelength-tuneable Bragg-grating reflection filter are optically coupled using a coupling lens according to an embodiment of the present invention.

According to an embodiment of the present invention, the waveguide platform is formed of a polymer material having a negative thermo-optic coefficient on a silicon substrate 106, and includes a wavelength tunable Bragg-grating 110 and a phase controlling heater 102.

Optical signals output from a semiconductor laser diode 200 are actively aligned through an optical coupling lens 204 with the Bragg-grating reflection filter 103.

The semiconductor laser diode 200 is mounted on a substrate 205 and cap-sealed for hermetic-sealing (207).

A lead-frame 206 for driving the semiconductor laser diode 200 and the semiconductor laser diode 200 are wire-bonded.

The axis of light emitted from the semiconductor laser diode 200 is actively aligned on an input facet of the waveguide 107 through a window 210 and the optical coupling lens 204.

The optical coupling lens 204 may be a ball-lens or an aspheric lens, and can be directly attached to the cap-sealed window 210.

In FIG. 3, the semiconductor laser diode 200 is parallel to the axis 400 of optical signals, but may also be inclined within 30 degrees.

Also, an mPD (monitoring PD) 209 for monitoring optical output may be mounted at the back of the semiconductor laser diode 200.

The semiconductor laser diode 200 and the mPD 209 mounted together are called a TO-head 203.

The optical coupling lens 204 may be included in the TO-head 203.

A front facet 201 of the semiconductor laser diode is anti-reflective (AR)-coated, with a residual reflection in 0.1% or less.

A rear facet opposite to the front facet 201 is high-reflective (HR)-coated, preferably to give a reflection of 30% or more.

For efficient optical coupling of the front facet 201 and the input surface (waveguide surface) 107, a spot-size converter may be integrated in the semiconductor laser diode.

The far-field angle may be 35 degrees or less in general.

The wavelength tunable Bragg-grating reflection filter 103 has the structure (a) of FIG. 2.

The etching depth in the core region 100 of the waveguide may be less than 1 um.

The material of the waveguide may have an absolute value of thermo-optic coefficient of 1.0×10-4/deg or greater.

The waveguide may be a buried-channel, a reversed buried-channel, a rib, a ridge, etc.

In the wavelength tunable external cavity laser according to the present invention, a current is applied to the heater 101 in the upper portion of the Bragg-grating 110 to control the oscillation wavelength by local heating, thus the temperature of the Bragg-grating 110 needs to be controlled precisely.

For this, a silicon substrate 106 and a lower portion of the TO-head 203 are attached to a thermo-electric cooler (TEC) 301 using an epoxy hardening method, laser-welding, soldering, mechanical bonding, etc.

The lower surface 303 of the TEC 301 radiates heat.

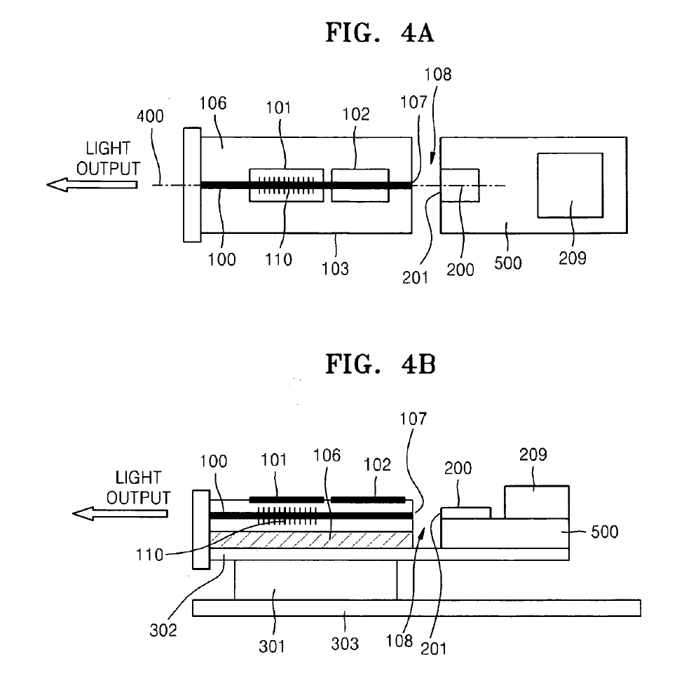

FIG. 4 includes a top view (a) and a side view (b) of a wavelength tunable external cavity laser where a semiconductor laser diode and a wavelength-tuneable Bragg-grating reflection filter are optically coupled without a coupling lens according to another embodiment of the present invention.

According to an embodiment of the present invention, a waveguide platform is formed of a polymer material having a negative thermo-optic coefficient on a silicon substrate 106, and includes a wavelength tunable Bragg-grating 110 and a phase controlling heater 102.

Optical signals output from the semiconductor laser diode 200 are actively aligned with the Bragg-grating reflection filter 103 without an optical coupling lens.

Since no optical coupling lens is used, in order to obtain 20% or more of optical coupling efficiency, a spot-size converter which allows light output from the front facet of the semiconductor laser diode 200 to have a far-field angle of 20 degrees or less, may be integrated.

Also, the width of an air gap between the front facet 201 and the input surface (waveguide surface) 107 may be 30 um or less.

The front facet 201 of the semiconductor laser diode 200 is AR-coated, preferably, with a residual reflection in 0.1% or less.

Also, a rear facet opposite to the front facet 201 is HR-coated, preferably, to give a reflection of 30% or more.

The semiconductor laser diode 200 is mounted on a substrate 500 and is actively aligned with the input surface (waveguide surface 107).

Also, a mPD 209 may be formed on the substrate 500 at the back of the semiconductor laser diode 200 to monitor optical output.

In FIG. 4, the semiconductor laser diode 200 is parallel to the axis 400 of optical signals, but may also be inclined within 30 degrees.

The wavelength tunable Bragg-grating reflection filter 103 has the structure (a) of FIG. 2.
The etching depth in the core region 100 of the waveguide may be less than 1 um.

The material of the waveguide may have an absolute value of thermo-optic coefficient of 1.0×10-4/deg or greater.

The waveguide may be a buried-channel, a reversed buried-channel, a rib, a ridge, etc.

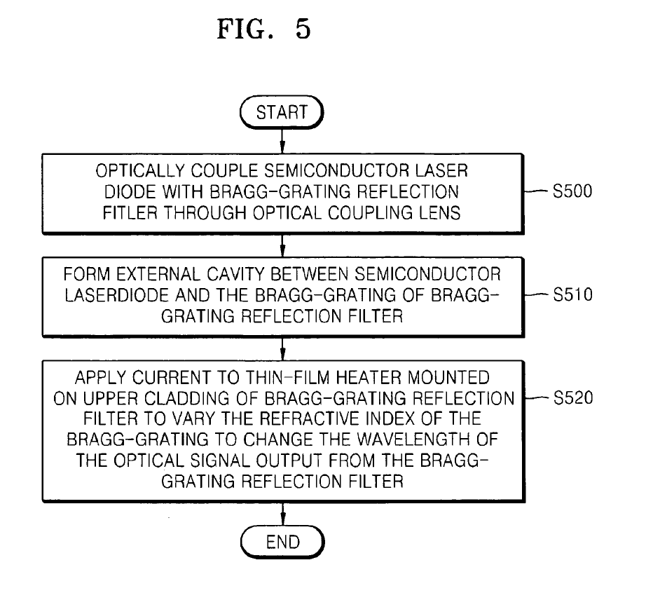

In the above structure, for thermal stability of the Bragg-grating reflection filter 103, the lower portion of the substrate 500, on which a silicon substrate 106 and the TO-head 203 are mounted, is attached to a cooling surface 302 of a thermo-electric cooler (TEC) 301 using an epoxy hardening method, laser-welding, soldering, mechanical bonding, etc.
The lower surface 303 of the TEC 301 radiates heat.
FIG. 5 illustrates the operation principle of the wavelength tunable external cavity laser according to an embodiment of the present invention.

The semiconductor laser diode are optically coupled with the Bragg-grating reflection filter through the optical coupling lens. (S500)

An external cavity is formed between the semiconductor laser diode and the Bragg-grating of the Bragg-grating reflection filter. (S510)

A current is applied to a thin-film heater mounted on an upper cladding of the Bragg-grating reflection filter to vary the refractive index of the Bragg-grating to change the wavelength of the optical signal output from the Bragg-grating reflection filter. (S520)

The invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.
While this invention has been particularly shown and described with reference to preferred embodiments thereof, it will be understood by those skilled in the art that various changes in form and detail may be made therein without departing from the spirit and scope of the invention as defined by the appended claims. The preferred embodiments should be considered in a descriptive sense only, and not for purposes of limitation. Therefore, the scope of the invention is defined not by the detailed description of the invention but by the appended claims, and all differences within the scope will be construed as being included in the present invention.

As described above, according to present invention, the semiconductor laser diode and the waveguide are actively aligned in the wavelength tunable external cavity laser, thereby increasing optical coupling efficiency and obtaining high optical output power.

Also, according to the present invention, stability and reproducibility in the optical coupling process are provided, thereby decreasing manufacturing fails.

In addition, using the optical coupling lens, the allowable range of the far-field angle of the spot-size converter of the semiconductor laser diode is increased, thereby reducing the cost of the device.

What is claimed is:

1. A wavelength tunable external cavity laser comprising:
a semiconductor laser diode that outputs multi-wavelength optical signals and is mounted on a first substrate; and
a wavelength tunable reflection filter that is mounted on a second substrate, outputs single wavelength optical signal among the multi-wavelength optical signals using resonance of external cavity formed between a semiconductor laser diode and a Bragg-grating having a predetermined period, and tunes the wavelength of the output single wavelength optical signal by varying the refractive index of the Bragg-grating.

2. The wavelength tunable external cavity laser of claim 1, wherein the first substrate is a Group III-V compound semiconductor substrate.

3. The wavelength tunable external cavity laser of claim 1, wherein the second substrate is formed of silicon based material, and the wavelength tunable reflection filter is formed of a polymer material having a negative thermo-optic coefficient and has a waveguide structure.

4. The wavelength tunable external cavity laser of claim 1, further comprising an optical coupling lens to increase optical coupling efficiency between the semiconductor laser diode and the waveguide.

5. The wavelength tunable external cavity laser of claim 1, further comprising:
a monitoring unit monitoring the characteristics of the optical output power from the semiconductor laser diode; and
a temperature controlling unit for controlling the temperature of the wavelength tunable filter.

6. The wavelength tunable external cavity laser of claim 3, wherein the waveguide has one of a buried-channel structure, a reversed buried-channel structure, a rib structure, and a ridge structure.
